(19) United States
(12) Patent Application Publication
(10) Pub. No.: US 2025/0008476 A1
(43) Pub. Date: Jan. 2, 2025

(54) EXCEPTIONAL RESOURCE POOL FOR POSITIONING IN NR SIDELINK POSITIONING

(71) Applicant: QUALCOMM Incorporated, San Diego, CA (US)

(72) Inventors: Alexandros MANOLAKOS, Athens, Attikí (GR); Mukesh KUMAR, Hyderabad, Punjab (IN); Srinivas YERRAMALLI, San Diego, CA (US)

(21) Appl. No.: 18/710,536

(22) PCT Filed: Dec. 7, 2022
(86) PCT No.: PCT/US2022/081112

§ 371 Date: May 15, 2024

(30) Foreign Application Priority Data
Jan. 25, 2022 (GR) 20220100066

(51) Int. Cl. H04W 64/00; H04L 5/00; H04W 24/08; H04W 92/18

(52) U.S. Cl. CPC H04W 64/00; H04L 5/0051; H04W 24/08; H04W 92/18

(57) ABSTRACT

Embodiments herein provide for the usage of exceptional resource pool for positioning (RP-P) when a UE transmits or receives RF signals for positioning via sidelink. The UE can determine whether one or more conditions have been met for using the exceptional RP-P during a positioning session, then transmit or receive the one or more reference signals accordingly. Various conditions may be established for using the exceptional RP-P, including radio link failure, high-priority/emergency conditions, a number of anchor UEs in non-exceptional RP-P being below a threshold, a number of anchor UEs in the exceptional RP-P being above the threshold, and others. The exceptional RP-P may be provided to the UE via an exceptional RP-P configuration from a base station, location server, or another UE.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

In a data communication network, various positioning techniques can be used to determine the position of a mobile device (referred to herein as a UE). Some of these positioning techniques may involve determining distance and/or angular information of RF signals received by one or more other UEs communicatively coupled with the data communication network. In a fifth generation (5G) wireless standard, referred to as New Radio (NR), direct communication between UEs (including the transmission of RF signals for positioning) may be referred to as sidelink (also referred to herein as “SL”). Such sidelink RF signals for positioning may use time and frequency resources that otherwise may be used by the data communication network.

### BRIEF SUMMARY

Embodiments herein provide for the usage of exceptional resource pool for positioning (RP-P) when a UE transmits or receives RF signals for positioning via sidelink. The UE can determine whether one or more conditions have been met for using the exceptional RP-P during a positioning session, then transmit or receive one or more reference signals accordingly. Various conditions may be established for using the exceptional RP-P, including radio link failure, high-priority/emergency conditions, a number of anchor UEs in non-exceptional RP-P being below a threshold, a number of anchor UEs in the exceptional RP-P being above the threshold, and others. The exceptional RP-P may be provided to the UE via an exceptional RP-P configuration from a base station, location server, or another UE.

An example method of using an exceptional resource pool for positioning (RP-P) for determining a position of a first UE, according to this disclosure, may comprise determining, at the first UE, whether one or more conditions have been met for using the exceptional RP-P during a positioning session, wherein the exceptional RP-P comprises wireless resources for transmitting or receiving one or more reference signals during the positioning session. The method also may comprise responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P.

An example first UE for using an exceptional resource pool for positioning (RP-P) for determining a position of the first UE, according to this disclosure, may comprise a transceiver, a memory, one or more processors communicatively coupled with the transceiver and the memory, wherein the one or more processors are configured to determine, at the first UE, whether one or more conditions have been met for using the exceptional RP-P during a positioning session, wherein the exceptional RP-P comprises wireless resources for transmitting or receiving one or more reference signals during the positioning session. The one or more processors further may be configured to, responsive to a determination that the one or more conditions have been met for using the exceptional RP-P during the positioning session, transmit or receive the one or more reference signals, with the transceiver, via a sidelink connection between the first UE and a second UE during the positioning session using the exceptional RP-P.

An example apparatus for using an exceptional resource pool for positioning (RP-P) for determining a position of a first UE, according to this disclosure, may comprise means for determining, at the first UE, whether one or more conditions have been met for using the exceptional RP-P during a positioning session, wherein the exceptional RP-P comprises wireless resources for transmitting or receiving one or more reference signals during the positioning session. The apparatus further may comprise means for, responsive to a determination that the one or more conditions have been met for using the exceptional RP-P during the positioning session, transmit or receive the one or more reference signals, with the first UE, via a sidelink connection between the first UE and a second UE during the positioning session using the exceptional RP-P.

According to this disclosure, an example non-transitory computer-readable medium stores instructions for using an exceptional resource pool for positioning (RP-P) for determining a position of a first UE, the instructions comprising code for determining, at the first UE, whether one or more conditions have been met for using the exceptional RP-P during a positioning session, wherein the exceptional RP-P comprises wireless resources for transmitting or receiving one or more reference signals during the positioning session. The instructions further may comprise code for responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIGS. 3A-3C are simplified diagrams of scenarios in which sidelink positioning may be used to determine the position of a target user equipment (UE).

FIG. 4 is a diagram illustrating an example process for allocating a resource pool for positioning (RP-P), including exceptional RP-P, which may be used in some embodiments.

FIG. 5 is a diagram illustrating an example configuration in which RP-P, including exceptional RP-P, may be allocated, which may be used in some embodiments.

FIG. 6 is a flow diagram of using an exceptional RP-P for determining the position of a UE, according to an embodiment.

FIG. 7 is a block diagram of an embodiment of a UE, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Position determination of a UE may be based at least in part on measurements of signals transmitted and/or received by the UE via sidelink. In some instances, these sidelink measurements may be used in conjunction with measurements via a wireless connection (Uu interface) between the UE and a base station to determine the position of the UE. A resource pool for positioning (RP-P) may establish resources (e.g., frequency-domain and/or time-domain resources in an orthogonal frequency-division multiplexing (OFDM) wireless communication scheme used in cellular communications) that can be used for such positioning sidelink signals. There may be times, however, when using the RP-P may not be available or possible. Embodiments herein provide for the use of exceptional RP-P in such instances, enabling positioning of the UE to be performed when it may not otherwise be possible using traditional RP-P.

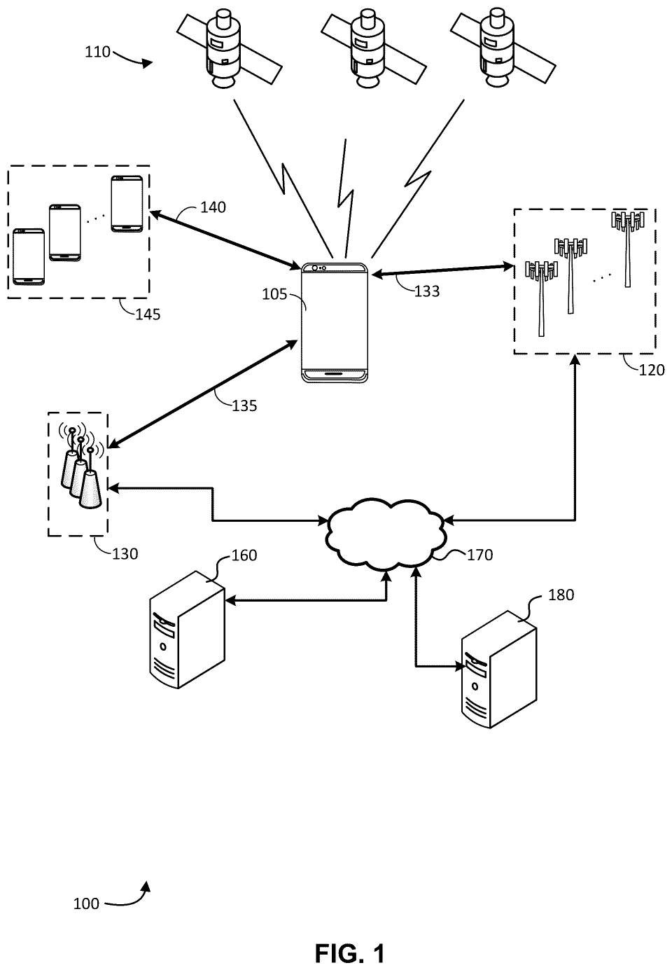

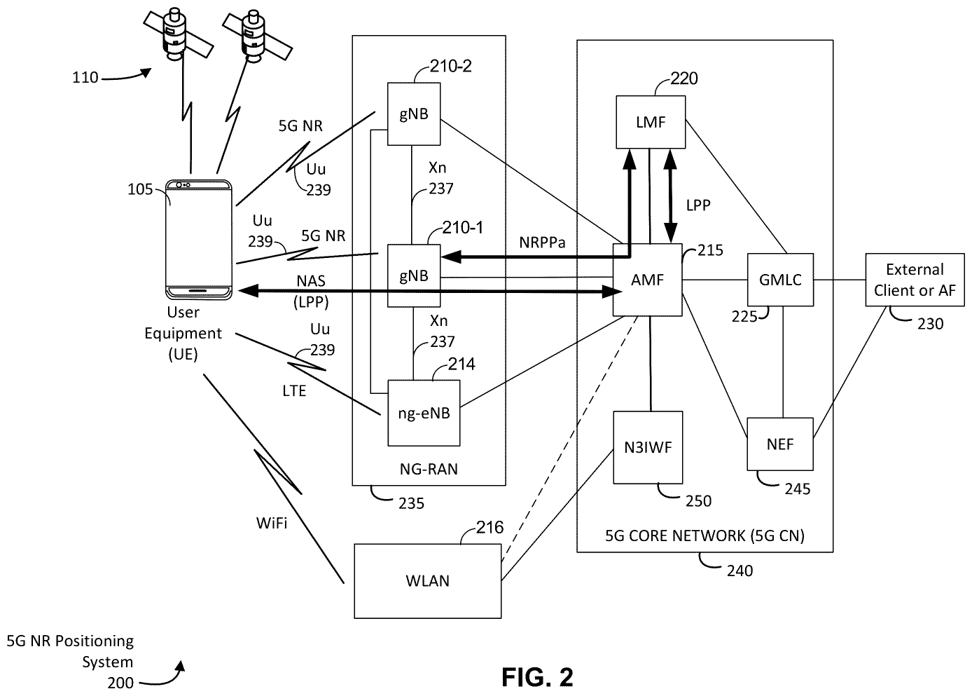

FIG. 1 is a simplified illustration of a positioning system 100 in which a UE 105, location server 160, and/or other components of the positioning system 100 can use the techniques provided herein for determining an estimated location of UE 105 using an exceptional RP-P, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

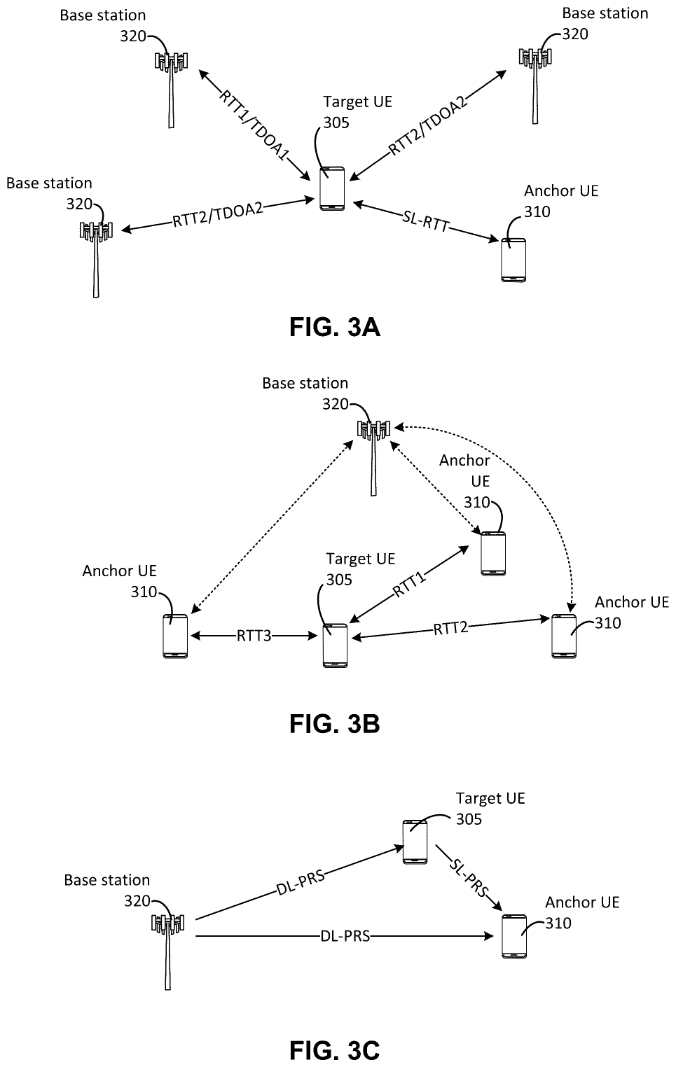

FIGS. 3A-3C are simplified diagrams of scenarios in which sidelink positioning may be used to determine the position of a target UE 305, according to some embodiments. One or more anchor UEs 310 may be used to send and/or receive reference signals via sidelink. As illustrated, positioning may be further determined using one or more base stations 320 (a Uu interface). It will be understood, however, that the signals used for positioning of the UE 305 may vary, depending on desired functionality. More particularly, some types of positioning may utilize signals other than RTT/TDOA as illustrated in FIGS. 3A-3C.

The diagram of FIG. 3A illustrates a configuration in which the positioning of a target UE 305 may comprise RTT and/or TDOA measurements between the target UE 305 and three base stations 320. In this configuration, the target UE 305 may be in coverage range for DL and/or UL signals via Uu connections with the base stations 320. Additionally, the anchor UE 310 at a known location may be used to improve the position determination for the target UE 305 by providing an additional anchor. As illustrated, ranging may be performed between the target UE 305 and anchor UE 310 by taking RTT measurements via the sidelink connection between the target UE 305 and anchor UE 310.

The diagram of FIG. 3B illustrates a configuration in which the positioning of a target UE 305 may sidelink only (SL-only) positioning/ranging. In this configuration, the target UE 305 may perform RTT measurements via sidelink connections between a plurality of anchor UEs 310. In this example, the target UE 305 may not be in UL coverage of the base station 320, and therefore each anchor UE 310 may report RTT measurement information to the network of via a Uu connection between each anchor UE 310 and the base station 320. (In cases in which a UE relays information between a remote UE and a base station, a UE may be referred to as a “relay” UE.) Such scenarios may exist when the target UE 305 has weaker transmission power than anchor UEs 310 (e.g., the target UE 305 comprises a wearable device, and anchor UEs comprise larger cellular phones, IOT devices, etc.). In other scenarios in which the target UE 305 is within UL coverage of the base station 320, the target UE 305 may report RTT measurements directly to the base station 320. In some embodiments, no base station 320 may be used, in which case one of the UEs (e.g., the target UE 305 or one of the anchor UEs 310) may receive RTT measurement information and determine the position of the target UE 305.

The diagram of FIG. 3C illustrates a configuration in which the positioning of a target UE 305 may comprise the target UE 305 and anchor UE 310 receiving a reference signal (DL-PRS) from the base station 320, and the target UE 305 sending a reference signal (SL-PRS) to the anchor UE 310. The positioning of the target UE can be determined based on known positions of the base station 320 and anchor UE 310 and a time difference between a time at which the anchor UE 310 receiving the reference signal from the base station 320 and a time at which the anchor UE 310 receives the reference signal from the target UE 305.

As previously discussed, the use of sidelink positioning (e.g., SL-only or Uu/SL positioning, as illustrated in FIGS. 3A-3C) may utilize RP-P. RP-P may be conveyed to UEs via a sidelink configuration (e.g., using techniques described hereafter), and may designate particular resource pools for sidelink reference signals in different scenarios. Resource pools comprise a set of resources (e.g., frequency and time resources in in an orthogonal frequency-division multiplexing (OFDM) scheme used by 4G and 5G cellular technologies) that may be used for the transmission of RF signals via sidelink for positioning. Each resource pool may further include a particular subcarrier spacing (SCS), cyclic prefix (CP) type, bandwidth (BW) (e.g., subcarriers, bandwidth part, etc.), time-domain location (e.g., periodicity and slot offset) Resource pools may comprise, for example, Tx resource pools for “Mode 1” sidelink positioning in which sidelink positioning is performed using one or more network-connected UEs, in which case network-based resource allocation may be received by a network-connected UE via a Uu interface with a base station (e.g., via Downlink Control Information (DCI) or Radio Resource Control (RRC)). Tx resource pools for “Mode 2” sidelink positioning in which autonomous resource selection is performed by UEs without network-based resource allocation. Resource pools may further comprise Rx resource pools, which may be used in either Mode 1 or Mode 2 sidelink positioning. Each RP-P configuration may be relayed via a physical sidelink control channel (PSCCH), which may reserve one or more SL-PRS configurations. Each of the one or more SL-PRS configurations of in RP-P may include respective specific physical layer features such as a number of symbols, comb type, comb-offset, number of subchannels, some channel size, and start resource block (RB). The RP-P configuration may further include a sensing configuration, power control, and/or Channel Busy Ratio (CBR).

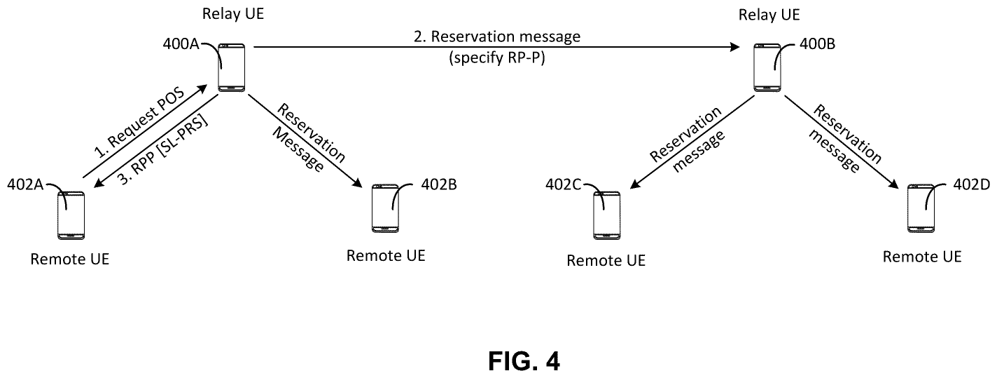

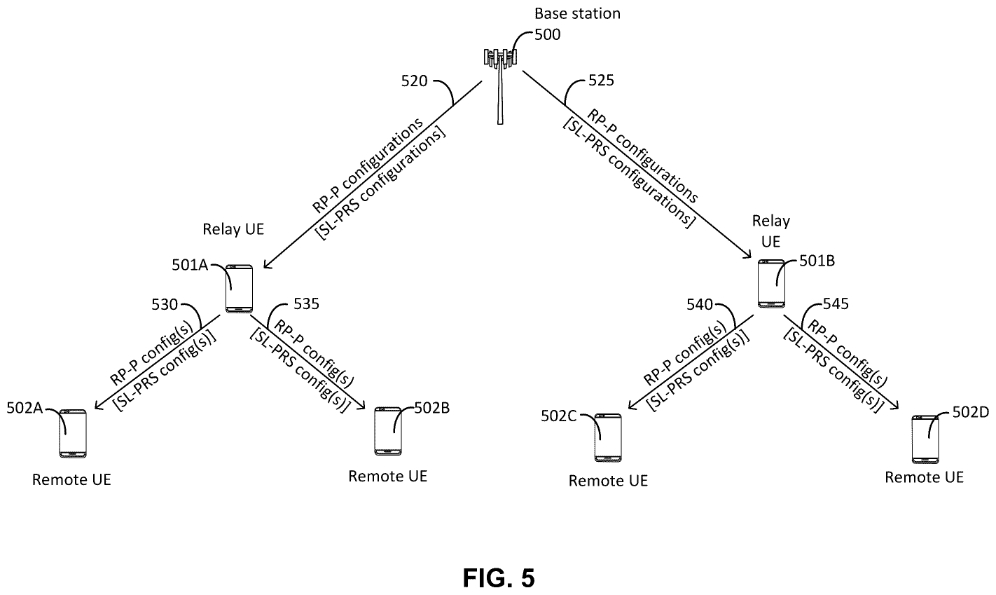

According to embodiments herein, exceptional RP-P can be designated and used in circumstances in which it may not be desirable or possible to perform sidelink positioning via the available resource pools of non-exceptional RP-P for sidelink. Such exceptional cases, described in more detail hereafter, may include situations similar to those that trigger the use of exceptional resource pools for communication, such as situations in which there may be physical layer problems, before the UE finishes and initiated connection, or during a handover of the UE. Exceptional RP-P may be used in additional or alternative situations, which are described in more detail hereafter. As with non-exceptional RP-P for sidelink, exceptional RP-P for sidelink may be configured or preconfigured, and may be allocated by the network or autonomously selected (e.g., used in Mode 1 or Mode 2 sidelink positioning). (A description of how configurations may be propagated to various UEs is provided hereafter with regard to FIGS. 4 and 5.) Further, according to some embodiments, exceptional RP-P may be preconfigured, preloaded, and/or hardcoded into UEs for different geographic regions or areas. Different countries, for example, may designate particular resources for exceptional RP-P in cases of public safety. Exceptional RP-P may be configured via dedicated signaling (e.g., PC5) and/or configured via System Information Block (SIB) via a Uu interface. In some embodiments, the exceptional RP-P may be broadcasted during the positioning session setup phase or discovery phase of a UE. Additionally or alternatively, exceptional RP-P may be assigned or allocated using the resource reservation techniques discuss hereafter with regard to FIGS. 4 and 5.

FIG. 4 is a diagram illustrating an example process for allocating RP-P, including exceptional RP-P, which may be used in some embodiments. In FIG. 4, a first relay UE 400A is serving remote UE 402A and remote UE 402B, and a second relay UE 400B is serving remote UE 402C and remote UE 402D. The number of relay UEs and the number of remote UEs that each relay UE serves can vary; these numbers are illustrative and not limiting. Each of the UEs is configured with a predefined set of RP-Ps, including exceptional PR-Ps. The predefined plurality of RP-Ps may be preloaded on the UE or configured by a serving base station, e.g., via RRC.

In the example of FIG. 4, a UE determines that an RP-P from the predefined plurality of RP-Ps should be reserved. Here, the first relay UE 400A receives, from a remote UE 402A, a request for a RP-P from the predefined plurality of RP-Ps. The remote UE 402A may issue a general request for any available RP-P, in which case the first relay UE 400A may select one of the RP-Ps from the predefined set of RP-Ps. Alternatively, the remote UE 402A may request a specific RP-P, in which case the first relay UE 400A may select that specific RP-P, or the first relay UE 400A may select a different RP-P, e.g., such as when the requested RP-P is unavailable due to being reserved by another remote UE or for some other reason.

In response, first relay UE 400A transmits a reservation message for reserving a specified RP-P. The reservation message may be transmitted via a broadcast, groupcast, or multicast message. The reservation message may be transmitted via a physical sidelink control channel (PSCCH), a physical sidelink shared channel (PSSCH), or a combination thereof. In one aspect, the reservation message is transmitted to the remote UE 402B and to the second relay UE 400B, and the second relay UE 400B relays the message to the remote UE 402C and remote UE 402D. Alternatively, the reservation message is transmitted to the second relay UE 400B, the remote UE 402B, the remote UE 402C, and the remote UE 402D simultaneously. Alternatively, the first relay UE 400A may send a set of unicast messages to neighboring UEs.

The reservation message may include additional information, such as, but not limited to, the following. The reservation message may indicate that a sidelink positioning reference signal (SL-PRS) will be transmitted using the reserved RP-P. The reservation message may specify particular SL-PRS resources within the RP-P that will be used. The reservation message may identify the remote UE that will use the reserved RP-P. The reservation message may include an RP-P identifier. The reservation message may include a zone identifier that specifies the geographic zone or zones to which the reservation applies.

The reservation message may include a priority indication that specifies the relative priority of a positioning operation to other types of operations that might also use the resources of the RP-P. For example, if the priority of the positioning operation is higher than the priority of a data or reference signal transmission by a neighboring UE, then the neighboring UEs are expected to avoid scheduling; otherwise, the neighboring UEs can schedule also.

The reservation request may include or imply a request that the UEs receiving the reservation request (and that are within the specified zone, if applicable) reduce interference during the reserved RP-P, e.g., by rate-matching, muting, puncturing, reducing transmit power, or combinations thereof, during the reserved RP-P, and, if applicable, within the specified SL-PRS resources. In the example shown in FIG. 4, the relay UE 400B, the remote UE 402B, the remote UE 402C, and the remote UE 402D may respond to the reservation request, e.g., by modifying an intended transmission to reduce interference with the remote UE 402B during the reserved RP-P.

In some aspects, the reservation message may include timing information associated with the reservation, such as, but not limited to, the timing information associated with the reservation comprises a start time of the RP-P, a stop time of the RP-P, a time offset of the RP-P, a periodicity of the RP-P, an indicator that the RP-P does not repeat (e.g., that this is a single-shot request), or combinations thereof.

In FIG. 4, the first relay UE 400A then sends a configuration message to remote UE 402A. The configuration message identifies the RP-P to be used by remote UE 402A and may also specify a subset of SL-PRS resources within the RP-P to be used by remote UE 402A. In some aspects, the SL-PRS resources within the reserved RP-P may be identified by an index. If a time domain index is used, the time-domain index may be relative to the RP-P. The SL-PRS resources to be used by the remote UE 402A may include all or a portion of the SL-PRS resources within the reserved RP-P.

In the example illustrated in FIG. 4, the first relay UE 400A sends the reservation message, but alternatively, the remote UE 402A may send the reservation message.

FIG. 5 is a diagram illustrating an example configuration in which RP-P, including exceptional RP-P, may be allocated, which may be used in some embodiments. Here, in contrast to the example of FIG. 4, RP-P allocation may be made by the network via a base station 500. In FIG. 5, the base station 500 is serving two relay UEs, a first relay UE 501A and a second relay UE 501B. The first relay UE 501A is serving remote UE 502A and remote UE 502B, while second relay UE 501B is serving remote UE 502C and remote UE 502D. The number of relay UEs and the number of remote UEs that each relay UE serves can vary; these numbers are illustrative and not limiting. In some aspects, for sidelink communication, including positioning, a UE is either a relay UE or a remote UE but not both. Each of the UEs is configured with a predefined set of RP-Ps. The predefined plurality of RP-Ps may be preloaded on the UE or configured by a serving base station, e.g., via RRC.

Generally put, in an RP-P allocation scheme, a base station assigns orthogonal sets of RP-P configurations to each of a set of relay UEs, and each relay UE decides on what resources within the assigned RP-Ps should be assigned to each of the remote UEs that it serves. In the example shown in FIG. 5, the base station 500 assigns a first set of RP-P configurations to the first relay UE 501A (as shown by arrow 520) and assigns a second set of RP-P configurations to the second relay UE 501B (as shown by arrow 525). In order to avoid, reduce, or mitigate interference between the remote UEs of one relay UE and the remote UEs of another relay UE, the sets of RP-P configurations provided to the two relay UEs should be different from each other (e.g., orthogonal in time, frequency, or both), but it is not mandatory that this be so.

In FIG. 5, the first relay UE 501A assigns a first subset of RP-P resources (i.e., a set of one or more RP-P configurations, including exceptional RP-P configurations) from the RP-P configurations assigned to it by the base station 500 to the remote UE 502A (as shown by arrow 530), and assigns a second set of RP-P resources from the RP-P configurations assigned to it by the base station 500 to the remote UE 502B (as shown by arrow 535). In order to avoid, reduce, or mitigate interference between the remote UE 502A and the remote UE 502B, the RP-P configuration(s) provided to the two remote UEs by the relay UE should be orthogonal in time, frequency, or both, but it is not mandatory that this be so. In FIG. 5, the second relay UE 501B assigns a first set of RP-P resources from the RP-P configurations assigned to it by the base station 500 to the remote UE 502C (as shown by arrow 540), and assigns a second set of RP-P resources from the RP-P configurations assigned to it by the base station 500 to the remote UE 502D (as shown by arrow 545). In order to avoid, reduce, or mitigate interference between the remote UE 502C and the remote UE 502D, the RP-P configuration(s) provided to the two remote UEs by the relay UE should be orthogonal in time, frequency, or both, but it is not mandatory that this be so.

As previously noted, various circumstances may give rise to the use of exceptional RP-P for sidelink, according to some embodiments. Generally put, the circumstances may be more critical or important than circumstances in which non-exceptional RP-P for sidelink are used, such as for public safety (e.g., positioning of mobile devices used by emergency personnel, such as police, firefighters, Emergency Medical Technicians (EMTs), and the like). Moreover, a plurality of exceptional RP-P may be established for different exceptional circumstances (e.g., one exceptional RP-P for used by emergency personnel, another for high-priority UE positioning, etc.). According to some embodiments, different resource pools can be used for Tx, Rx, or both. In some embodiments, exceptional RP-P may be different than exceptional resource pools for communication. A decision of whether to use an exceptional RP-P may be made, for example, by a UE (e.g. a target UE), based on determining a situation in which exceptional RP-P is to be used has arisen.

A first situation in which exceptional RP-P may be used may arise when a UE determines Uu Positioning Resource Quality is lower than a threshold. For example, in a joint positioning session in which measurements are made over Uu and SL interfaces (e.g., as illustrated in the example of FIG. 3A), if a quality of measurements obtained via Uu interfaces (e.g., RTT and/or ToA measurements) fall below a threshold, the UE an exceptional RP-P may be used between the target UE and an anchor UE to perform additional sidelink measurements. This can increase the accuracy of a resulting position determination for the target UE. In some instances, the exceptional RP-P may have a relatively high bandwidth compared with non-exceptional RP-P (e.g., the exceptional RP-P may occur in an unlicensed spectrum having relatively high BW, versus non-exceptional RP-P having relatively low (e.g., 20-40 MHz) bandwidth licensed spectrum).

Another situation in which exceptional RP-P may be used may arise when a UE does not have sensing results due to a change (e.g., reconfiguration) in the Tx sidelink RP-P. For example, when a network reconfigures a Tx RP-P (e.g., of a non-exceptional RP-P), a UE may need to perform sensing (e.g., to determine whether the channel is too busy) to determine sidelink transmission parameters. If such sensing is not yet completed when a UE is scheduled to use the Tx RP-P, embodiments may utilize an exceptional RP-P (e.g., an exceptional Tx RP-P), rather than waiting for sensing to complete. According to some embodiments, because reconfiguration of exceptional RP-P may happen relatively rarely (e.g., relative to non-exceptional RP-P), the likelihood that sensing would need to be performed for the exceptional RP-P may be correspondingly relatively low.

Another situation in which exceptional RP-P may be used may arise when a UE detects a radio link failure with the serving base station. Thus, according to some embodiments, an exceptional RP-P may be used to perform positioning of a target UE via a sidelink connection with an anchor UE in cases where the target UE detects a radio link failure with its serving base station.

Another situation in which exceptional RP-P may be used may arise when a UE is scheduled to perform positioning before the UE is able to finish and initiated connection establishment (or reestablishment). Thus, an exceptional RP-P may be used to perform positioning of a target UE via a sidelink connection with an anchor UE in cases where the target UE detects a radio link failure with a base station or UE with which an initiated connection has not yet been established.

Another situation in which exceptional RP-P may be used may arise when a UE is scheduled to perform positioning at a time during which a synchronization source has changed or been updated. In sidelink, there are many ways in which UEs may be synchronized, including different levels of GNSS-based synchronization base station-based synchronization, and UE-based synchronization. When a UE experiences a change or update in a synchronization source, there may be a resulting transition period during which the UE is attempting to synchronize width of the new synchronization source. During this time, an exceptional RP-P may be used to determine the location of the UE.

Another situation in which exceptional RP-P may be used may arise when a UE is scheduled to perform positioning at a time during which a synchronization source quality is lower than a threshold. According to some embodiments, if the UE utilizes a synchronization source having a priority level below a certain threshold and/or of a certain type of synchronization source is used (e.g., a UE-based synchronization source), an exceptional RP-P may be used to help ensure accurate position determination of the UE. Embodiments may use additional or alternative metrics for synchronization quality.

Another situation in which exceptional RP-P may be used may arise if a UE is not configured in Mode 1 sidelink positioning (e.g., in which the network assigns RP-P to use). In this case, the UE may therefore be configured in Mode 2 sidelink positioning (e.g., in which, RP-P reservation is managed by the UE's themselves). In such instances, a UE may use an exceptional RP-P when sensing results for the standard Tx RP-P is not available (similar to the previously-described scenario in which sensing results were not available).

Yet another situation in which exceptional RP-P may be used may arise if the number of anchor UEs (Pos-Peer UEs) detected in the non-exceptional RP-P is smaller than a threshold. Because UEs can declare their presence in a resource pool, a target UE may, for example, be able to monitor RP-Ps to determine how many anchor UEs are available for positioning for a given non-exceptional RP-P. If the non-exceptional RP-P has fewer anchor UEs than a given threshold, the target UE may then (e.g., additionally or alternatively) use the exceptional RP-P. Because the exceptional RP-P may be set aside for high-priority purposes (e.g., emergencies or public safety), UEs may be required to monitor and declare their presence in the exceptional RP-P, thereby increasing the likelihood that exceptional RP-P has a larger number of UEs than non-exceptional RP-P.

Additionally or alternatively, according to some embodiments, the exceptional RP-P may be used in cases in which the number of anchor UEs (Pos-Peer UEs) detected in the exceptional RP-P is greater than a threshold. In some embodiments, this may be used in conjunction with the number of anchor UEs detected in the non-exceptional RP-P. For example, the exceptional RP-P may be used in cases where the number of UEs in the exceptional RP-P is greater than (or a certain percentage or multiplier larger than) the number of UEs in the non-exceptional RP-P. In some embodiments, the number of anchor UEs detected in the exceptional RP-P and the number of anchor UEs detected in the non-exceptional RP-P may be analyzed independently when determining whether to use the exceptional RP-P.

According to some embodiments, a determination of whether to use the exceptional RP-P may be made when the UE is in an NR RRC IDLE/INACTIVE mode. For example, in some embodiments, when cell reselection is performed but does not yet have sensing results for a target cell, the exceptional RP-P may be used. Additionally or alternatively, when a UE initiates a transition to CONNECTED mode and a Mode 2 TX resource pool for positioning is not yet configured (same as in NR IDLE), the exceptional RP-P may be used.

According to some embodiments, the exceptional RP-P may be used in urgent and/or high-priority situations (e.g., high-priority position requests). As previously noted, some countries or regions may dedicate certain resources for exceptional RP-P for public safety-related positioning (e.g., positioning for firefighters, police, etc.). Similarly, emergency positioning (e.g., positioning during 9-1-1 telephone calls) and/or other high-priority positioning may use the exceptional RP-P. In some embodiments, this usage may be further based on CBR of the non-exceptional RP-P. Broadly put, exceptional RP-P may be used when an urgent/high-priority positioning request is received and (optionally) CBR of the non-exceptional RP-P is higher than a threshold.

According to some embodiments, CBR alone may be used to determine whether an exceptional RP-P may be used. For example, according to some embodiments, if CBR of an exceptional RP-P is lower than a threshold, the exceptional RP-P may be used. As noted, this factor may be used in conjunction with one or more other factors for determining whether an exceptional RP-P may be used, as previously described.

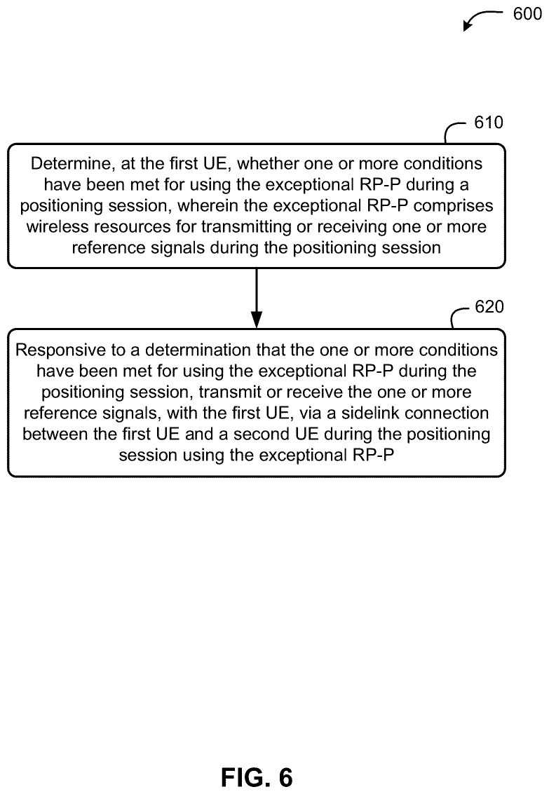

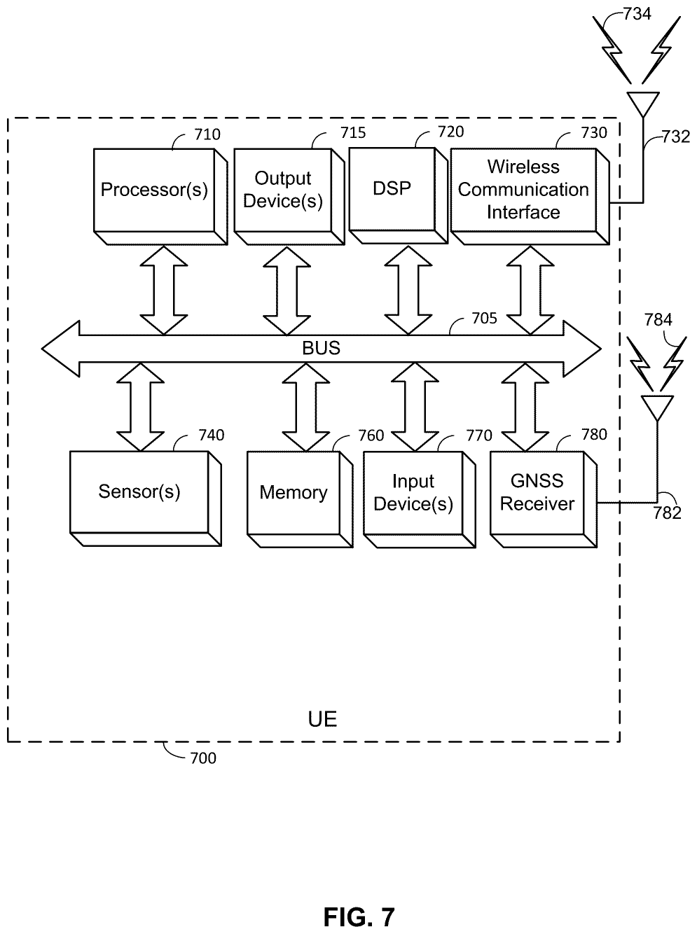

FIG. 6 is a flow diagram of a method 600 of using an exceptional RP-P determining the position of a user equipment, according to an embodiment. Means for performing the functionality illustrated in one or more of the blocks shown in FIG. 6 may be performed by hardware and/or software components of a UE. Example components of a UE are illustrated in FIG. 7, which is described in more detail below.

At block 610, the method comprises determining at a first UE, whether one or more conditions have been met for using the exceptional RP-P during a positioning session, wherein the exceptional RP-P comprises wireless resources for transmitting or receiving one or more reference signals during the positioning session. Reference signals may comprise SRS and/or PRS, for example. As discussed in the previously-described embodiments, any of a variety of scenarios may exist in which the exceptional RP-P may be used. As such, determining whether the one or more conditions have been met for using the exceptional RP-P may comprise determining any of a variety of conditions have been met, some of which are summarized hereafter. Means for performing functionality at block 610 may comprise bus 705, processor(s) 710, wireless communication interface 730, sensors 740, memory 760, GNSS receiver 780, and/or other components of a UE, such as those as illustrated in FIG. 7 and described hereafter.

At block 620, the method comprises, responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P. The positioning session may be coordinated by a location server, base station, the target UE, or other UE (e.g., the second UE)). The positioning session may be part of a SL-only or combined SL/Uu positioning technique performed to determine the position of the target UE. In cases in which the transmitting or receiving the one or more reference signals comprises receiving the one or more reference signals, the method 600 may further comprise performing measurements of the received one or more reference signals; and either (i) determining the position of the first UE based at least in part on the measurements of the received one or more reference signals, or (ii) sending information indicative of the measurements of the received one or more reference signals to another device. Means for performing functionality at block 620 may comprise bus 705, processor(s) 710, wireless communication interface 730, sensors 740, memory 760, GNSS receiver 780, and/or other components of a UE, such as those as illustrated in FIG. 7 and described hereafter.

Depending on desired functionality, determining the one or more conditions have been met for using the exceptional RP-P during the positioning session may comprise, for example, determining that a measurement quality of a SL interface between the first UE and one or more of the other UEs is lower than a threshold, a Positioning Resource Quality of a Uu interface between the first UE and a base station is lower than a threshold. In instances in which the transmitting or receiving the one or more reference signals comprises transmitting the one or more reference signals, determining the one or more conditions have been met for using the exceptional RP-P during the positioning session may comprise determining that the first UE does not have sensing results associated with a non-exceptional sidelink RP-P, or a non-exceptional RP-P is not yet configured, or a combination thereof. Determining the one or more conditions have been met for using the exceptional RP-P during the positioning session additionally or alternatively may comprise determining that a radio link failure has occurred between the first UE and a base station of the first UE, determining that the positioning session occurs before the first UE is able to finish an initiated connection establishment or reestablishment with a base station, determining that a synchronization source quality of a synchronization source for the first UE is lower than a threshold, determining that a number of UEs participating in the positioning session detected in a non-exceptional RP-P is smaller than a threshold, determining that a number of UEs participating in the positioning session detected in the exceptional RP-P is greater than a threshold, determining that the first UE does not yet have sensing results for a target cell after cell reselection, and/or a priority of the positioning session is above a threshold. In cases in which the first UE transmits the one or more reference signals, determining the one or more conditions have been met for using the exceptional RP-P during the positioning session additionally or alternatively may comprise determining that a Tx resource pool for positioning is not yet configured. Additionally or alternatively, determining the one or more conditions have been met for using the exceptional RP-P during the positioning session may comprise determining that a priority of the determining the position of the first UE is above a threshold, determining that a CBR of a non-exceptional (e.g., standard) RP-P is higher than a threshold, and/or determining that a CBR of the exceptional RP-P is lower than a threshold. According to some embodiments, the method 600 may further comprise determining the wireless resources of the exceptional RP-P based on a geographical location of the first UE. As noted, certain jurisdictions (e.g. countries) may designate exceptional RP-P for public safety, emergency, and/or other high-priority situations. This may be preconfigured and/or hard-coded in the UE (e.g., during manufacture or during a firmware update)

According to some embodiments, the exceptional RP-P may be provided to the UE in an exceptional RP-P configuration. Thus, according to some embodiments, the method 600 may further comprise determining the wireless resources of the exceptional RP-P based on an exceptional RP-P configuration received at the first UE. Such embodiments may further comprise receiving the exceptional RP-P configuration via the sidelink connection with the second UE, receiving the exceptional RP-P configuration through a System Information Block (SIB) via a Uu interface with a base station, and/or receiving the exceptional RP-P configuration via a broadcast message received by the first UE during a positioning session setup phase or a discovery phase. In a discovery phase, for example, a particular anchor UE may broadcast a non-exceptional RP-P and/or exceptional RP-P to use when the first UE is transmitting or receiving reference signals for positioning via a sidelink connection with the particular anchor UE.

FIG. 7 is a block diagram of an embodiment of a UE 700, which can be utilized as described herein above (e.g., in association with FIGS. 1-6). For example, the UE 700 can perform one or more of the functions of the method shown in FIG. 6. The UE 700 may correspond to any of the UEs described herein, including UE 105, UE 305, and/or any of the UEs in FIGS. 4 and 5. It should be noted that FIG. 7 is meant only to provide a generalized illustration of various components, any or all of which may be utilized as appropriate. It can be noted that, in some instances, components illustrated by FIG. 7 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 7.

The UE 700 is shown comprising hardware elements that can be electrically coupled via a bus 705 (or may otherwise be in communication, as appropriate). The hardware elements may include a processor(s) 710 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 710 may comprise one or more processing units, which may be housed in a single integrated circuit (IC) or multiple ICs. As shown in FIG. 7, some embodiments may have a separate DSP 720, depending on desired functionality. Location determination and/or other determinations based on wireless communication may be provided in the processor(s) 710 and/or wireless communication interface 730 (discussed below). The UE 700 also can include one or more input devices 770, which can include without limitation one or more keyboards, touch screens, touch pads, microphones, buttons, dials, switches, and/or the like; and one or more output devices 715, which can include without limitation one or more displays (e.g., touch screens), light emitting diodes (LEDs), speakers, and/or the like.

The UE 700 may also include a wireless communication interface 730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 700 to communicate with other devices as described in the embodiments above. The wireless communication interface 730 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 732 that send and/or receive wireless signals 734. According to some embodiments, the wireless communication antenna(s) 732 may comprise a plurality of discrete antennas, antenna arrays, or any combination thereof. The antenna(s) 732 may be capable of transmitting and receiving wireless signals using beams (e.g., Tx beams and Rx beams). Beam formation may be performed using digital and/or analog beam formation techniques, with respective digital and/or analog circuitry. The wireless communication interface 730 may include such circuitry.

Depending on desired functionality, the wireless communication interface 730 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 700 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 700 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 700 may also include a Global Navigation Satellite System (GNSS) receiver 780 capable of receiving signals 784 from one or more GNSS satellites using an antenna 782 (which could be the same as antenna 732). Positioning based on GNSS signal measurement can be utilized to complement and/or incorporate the techniques described herein. The GNSS receiver 780 can extract a position of the UE 700, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 780 is illustrated in FIG. 7 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 710, DSP 720, and/or a processor within the wireless communication interface 730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 710 or DSP 720.

The UE 700 may further include and/or be in communication with a memory 760. The memory 760 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 of the UE 700 also can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the UE 700 (and/or processor(s) 710 or DSP 720 within UE 700). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of using an exceptional resource pool for positioning (RP-P) for determining a position of a first UE, the method comprising: determining, at the first UE, whether one or more conditions have been met for using the exceptional RP-P during a positioning session, wherein the exceptional RP-P comprises wireless resources for transmitting or receiving one or more reference signals during the positioning session; and responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P.
Clause 2. The method of clause 1, wherein the first UE receives the one or more reference signals, and wherein the method further comprises: performing measurements of the received one or more reference signals; and either: (i) determining the position of the first UE based at least in part on the measurements of the received one or more reference signals, or (ii) sending information indicative of the measurements of the received one or more reference signals to another device.
Clause 3. The method any of clauses 1-2 wherein determining the one or more conditions have been met for using the exceptional RP-P during the positioning session comprises determining that a measurement quality of a SL interface between the first UE and one or more other UEs is lower than a threshold, a Positioning Resource Quality of a Uu interface between the first UE and a base station is lower than a threshold, that a radio link failure has occurred between the first UE and a base station of the first UE, the positioning session occurs before the first UE is able to finish an initiated connection establishment or reestablishment with a base station, or a synchronization source quality of a synchronization source for the first UE during a synchronization source change/update is lower than a threshold, or a combination thereof.
Clause 4. The method any of clauses 1-3 wherein determining the one or more conditions have been met for using the exceptional RP-P during the positioning session comprises determining that a number of UEs participating in the positioning session detected in a non-exceptional RP-P is smaller than a threshold, a number of UEs participating in the positioning session detected in the exceptional RP-P is greater than a threshold, the first UE does not yet have sensing results for a target cell after cell reselection, or a priority of the positioning session is above a threshold, or a combination thereof.
Clause 5. The method any of clauses 1-4 wherein determining the one or more conditions have been met for using the exceptional RP-P during the positioning session comprises determining that a Channel Busy Ratio (CBR) of a non-exceptional RP-P is higher than a threshold, or a CBR of the exceptional RP-P is lower than a threshold, or a combination thereof.
Clause 6. The method any of clauses 1-5 wherein the first UE transmits the one or more reference signals, and wherein determining the one or more conditions have been met for using the exceptional RP-P during the positioning session comprises determining that the first UE does not have sensing results associated with a non-exceptional sidelink RP-P, or a non-exceptional RP-P is not yet configured, or a combination thereof.
Clause 7. The method any of clauses 1-6 further comprising determining the wireless resources of the exceptional RP-P based on a geographical location of the first UE.
Clause 8. The method any of clauses 1-7 further comprising determining the wireless resources of the exceptional RP-P based on an exceptional RP-P configuration received at the first UE.
Clause 9. The method any of clauses 1-8 further comprising receiving the exceptional RP-P configuration via: the sidelink connection with the second UE, a System Information Block (SIB) via a Uu interface with a base station, or a broadcast message received by the first UE during a positioning session setup phase or a discovery phase.
Clause 10. A first UE for using an exceptional resource pool for positioning (RP-P) for determining a position of the first UE, the first UE comprising: a transceiver; a memory; and one or more processors communicatively coupled with the transceiver and the memory, wherein the one or more processors are configured to: determine, at the first UE, whether one or more conditions have been met for using the exceptional RP-P during a positioning session, wherein the exceptional RP-P comprises wireless resources for transmitting or receiving one or more reference signals during the positioning session; and responsive to a determination that the one or more conditions have been met for using the exceptional RP-P during the positioning session, transmit or receive the one or more reference signals, with the transceiver, via a sidelink connection between the first UE and a second UE during the positioning session using the exceptional RP-P.
Clause 11. The first UE of clause 10, wherein the one or more processors are further configured to: perform measurements of the received one or more reference signals; and either: (i) determine the position of the first UE based at least in part on the measurements of the received one or more reference signals, or (ii) send information indicative of the measurements of the received one or more reference signals to another device via the transceiver.
Clause 12. The first UE of any of clauses 10-11 wherein, to determine the one or more conditions have been met for using the exceptional RP-P during the positioning session, the one or more processors are configured to determine that a measurement quality of a SL interface between the first UE and one or more other UEs is lower than a threshold, a Positioning Resource Quality of a Uu interface between the first UE and a base station is lower than a threshold, that a radio link failure has occurred between the first UE and a base station of the first UE, the positioning session occurs before the first UE is able to finish an initiated connection establishment or reestablishment with a base station, or a synchronization source quality of a synchronization source for the first UE during a synchronization source change/update is lower than a threshold, or a combination thereof.
Clause 13. The first UE of any of clauses 10-12 wherein, to determine the one or more conditions have been met for using the exceptional RP-P during the positioning session, the one or more processors are configured to determine that a number of UEs participating in the positioning session detected in a non-exceptional RP-P is smaller than a threshold, a number of UEs participating in the positioning session detected in the exceptional RP-P is greater than a threshold, the first UE does not yet have sensing results for a target cell after cell reselection, or a priority of the positioning session is above a threshold, or a combination thereof.
Clause 14. The first UE of any of clauses 10-13 wherein, to determine the one or more conditions have been met for using the exceptional RP-P during the positioning session, the one or more processors are configured to determine that a Channel Busy Ratio (CBR) of a non-exceptional RP-P is higher than a threshold, or a CBR of the exceptional RP-P is lower than a threshold, or a combination thereof.
Clause 15. The first UE of any of clauses 10-14 wherein, to determine the one or more conditions have been met for using the exceptional RP-P during the positioning session, the one or more processors are configured to determine that the first UE does not have sensing results associated with a non-exceptional sidelink RP-P, or a non-exceptional RP-P is not yet configured, or a combination thereof.
Clause 16. The first UE of any of clauses 10-15 wherein the one or more processors are further configured to determine the wireless resources of the exceptional RP-P based on a geographical location of the first UE.
Clause 17. The first UE of any of clauses 10-16 wherein the one or more processors are further configured to determine the wireless resources of the exceptional RP-P based on an exceptional RP-P configuration received at the first UE.
Clause 18. The first UE of any of clauses 10-17 wherein the one or more processors are further configured to receive the exceptional RP-P configuration via: the sidelink connection with the second UE, a System Information Block (SIB) via a Uu interface with a base station, or a broadcast message received by the first UE during a positioning session setup phase or a discovery phase.
Clause 19. An apparatus for using an exceptional resource pool for positioning (RP-P) for determining a position of a first UE, the apparatus comprising: means for determining, at the first UE, whether one or more conditions have been met for using the exceptional RP-P during a positioning session, wherein the exceptional RP-P comprises wireless resources for transmitting or receiving one or more reference signals during the positioning session; and means for, responsive to a determination that the one or more conditions have been met for using the exceptional RP-P during the positioning session, transmit or receive the one or more reference signals, with the first UE, via a sidelink connection between the first UE and a second UE during the positioning session using the exceptional RP-P.
Clause 20. The apparatus of clause 19, further comprising: means for performing measurements of the received one or more reference signals; and either: (i) determining the position of the first UE based at least in part on the measurements of the received one or more reference signals, or (ii) sending information indicative of the measurements of the received one or more reference signals to another device.
Clause 21. The apparatus of any of clauses 19-20 wherein the means for determining the one or more conditions have been met for using the exceptional RP-P during the positioning session comprises means for determining that: a measurement quality of a SL interface between the first UE and one or more other UEs is lower than a threshold, a Positioning Resource Quality of a Uu interface between the first UE and a base station is lower than a threshold, that a radio link failure has occurred between the first UE and a base station of the first UE, the positioning session occurs before the first UE is able to finish an initiated connection establishment or reestablishment with a base station, or a synchronization source quality of a synchronization source for the first UE during a synchronization source change/update is lower than a threshold, or a combination thereof.
Clause 22. The apparatus of any of clauses 19-21 wherein the means for determining the one or more conditions have been met for using the exceptional RP-P during the positioning session comprises means for determining that: a number of UEs participating in the positioning session detected in a non-exceptional RP-P is smaller than a threshold, a number of UEs participating in the positioning session detected in the exceptional RP-P is greater than a threshold, the first UE does not yet have sensing results for a target cell after cell reselection, or a priority of the positioning session is above a threshold, or a combination thereof.
Clause 23. The apparatus of any of clauses 19-22 wherein the means for determining the one or more conditions have been met for using the exceptional RP-P during the positioning session comprises means for determining that: a Channel Busy Ratio (CBR) of a non-exceptional RP-P is higher than a threshold, or a CBR of the exceptional RP-P is lower than a threshold, or a combination thereof.
Clause 24. The apparatus of any of clauses 19-23 wherein the means for determining the one or more conditions have been met for using the exceptional RP-P during the positioning session comprises means for determining that: the first UE does not have sensing results associated with a non-exceptional sidelink RP-P, or a non-exceptional RP-P is not yet configured, or a combination thereof.
Clause 25. The apparatus of any of clauses 19-24 further comprising means for determining the wireless resources of the exceptional RP-P based on a geographical location of the first UE.
Clause 26. The apparatus of any of clauses 19-25 further comprising means for determining the wireless resources of the exceptional RP-P based on an exceptional RP-P configuration received at the first UE.
Clause 27. The apparatus of any of clauses 19-26 further comprising means for receiving the exceptional RP-P configuration via: the sidelink connection with the second UE, a System Information Block (SIB) via a Uu interface with a base station, or a broadcast message received by the first UE during a positioning session setup phase or a discovery phase.
Clause 28. A non-transitory computer-readable medium storing instructions for using an exceptional resource pool for positioning (RP-P) for determining a position of a first UE, the instructions comprising code for: determining, at the first UE, whether one or more conditions have been met for using the exceptional RP-P during a positioning session, wherein the exceptional RP-P comprises wireless resources for transmitting or receiving one or more reference signals during the positioning session; and responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P.
Clause 29. The computer-readable medium of clause 28, wherein the instructions further comprise code for: performing measurements of the received one or more reference signals; and either: (i) determining the position of the first UE based at least in part on the measurements of the received one or more reference signals, or (ii) sending information indicative of the measurements of the received one or more reference signals to another device.
Clause 30. The computer-readable medium of any of clauses 28-29 wherein the code for determining the one or more conditions have been met for using the exceptional RP-P during the positioning session comprises code for determining that: a measurement quality of a SL interface between the first UE and one or more other UEs is lower than a threshold, a Positioning Resource Quality of a Uu interface between the first UE and a base station is lower than a threshold, that a radio link failure has occurred between the first UE and a base station of the first UE, the positioning session occurs before the first UE is able to finish an initiated connection establishment or reestablishment with a base station, or a synchronization source quality of a synchronization source for the first UE during a synchronization source change/update is lower than a threshold, or a combination thereof.

What is claimed is:

1. A method of using an exceptional resource pool for positioning (RP-P) for determining a position of a first UE, the method comprising:
determining, at the first UE, whether one or more conditions have been met for using the exceptional RP-P during a positioning session, wherein the exceptional RP-P comprises wireless resources for transmitting or receiving one or more reference signals during the positioning session; and
responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P.

2. The method of claim 1, wherein the transmitting or receiving the one or more reference signals comprises receiving the one or more reference signals, and wherein the method further comprises:
performing measurements of the received one or more reference signals; and either:
(i) determining the position of the first UE based at least in part on the measurements of the received one or more reference signals, or
(ii) sending information indicative of the measurements of the received one or more reference signals to another device.

3. The method of claim 1, wherein determining the one or more conditions have been met for using the exceptional RP-P during the positioning session comprises determining that:
a measurement quality of a side link (SL) interface between the first UE and one or more other UEs is lower than a threshold,
a Positioning Resource Quality of a Uu interface between the first UE and a base station is lower than a threshold,
a radio link failure has occurred between the first UE and a base station of the first UE,
the positioning session occurs before the first UE is able to finish an initiated connection establishment or reestablishment with a base station, or
a synchronization source quality of a synchronization source for the first UE during a synchronization source change/update is lower than a threshold, or
a combination thereof.

4. The method of claim 1, wherein determining the one or more conditions have been met for using the exceptional RP-P during the positioning session comprises determining that:
a number of UEs participating in the positioning session detected in a non-exceptional RP-P is smaller than a threshold,
a number of UEs participating in the positioning session detected in the exceptional RP-P is greater than a threshold,
the first UE does not yet have sensing results for a target cell after cell reselection, or
a priority of the positioning session is above a threshold, or
a combination thereof.

5. The method of claim 1, wherein determining the one or more conditions have been met for using the exceptional RP-P during the positioning session comprises determining that:
a Channel Busy Ratio (CBR) of a non-exceptional RP-P is higher than a threshold, or
a CBR of the exceptional RP-P is lower than a threshold, or
a combination thereof.

6. The method of claim 1, wherein transmitting or receiving the one or more reference signals comprises transmitting the one or more reference signals, and wherein determining the one or more conditions have been met for using the exceptional RP-P during the positioning session comprises determining that:
the first UE does not have sensing results associated with a non-exceptional sidelink RP-P, or
a non-exceptional RP-P is not yet configured, or
a combination thereof.

7. The method of claim 1, further comprising determining the wireless resources of the exceptional RP-P based on a geographical location of the first UE.

8. The method of claim 1, further comprising determining the wireless resources of the exceptional RP-P based on an exceptional RP-P configuration received at the first UE.

9. The method of claim 8, further comprising receiving the exceptional RP-P configuration via:
the sidelink connection with the second UE,
a System Information Block (SIB) via a Uu interface with a base station, or
a broadcast message received by the first UE during a positioning session setup phase or a discovery phase.

10. A first UE for using an exceptional resource pool for positioning (RP-P) for determining a position of the first UE, the first UE comprising:
a transceiver;
a memory; and
one or more processors communicatively coupled with the transceiver and the memory, wherein the one or more processors are configured to:
determine, at the first UE, whether one or more conditions have been met for using the exceptional RP-P during a positioning session, wherein the exceptional RP-P comprises wireless resources for transmitting or receiving one or more reference signals during the positioning session; and
responsive to a determination that the one or more conditions have been met for using the exceptional RP-P during the positioning session, transmit or receive the one or more reference signals, with the transceiver, via a sidelink connection between the first UE and a second UE during the positioning session using the exceptional RP-P.

11. The first UE of claim 10, wherein the one or more processors are further configured to receive the one or more reference signals, and wherein the one or more processors are further configured to:
perform measurements of the received one or more reference signals; and either:
(i) determine the position of the first UE based at least in part on the measurements of the received one or more reference signals, or
(ii) send information indicative of the measurements of the received one or more reference signals to another device via the transceiver.

12. The first UE of claim 10, wherein, to determine the one or more conditions have been met for using the exceptional RP-P during the positioning session, the one or more processors are configured to determine that:
a measurement quality of a SL interface between the first UE and one or more other UEs is lower than a threshold,
a Positioning Resource Quality of a Uu interface between the first UE and a base station is lower than a threshold,
that a radio link failure has occurred between the first UE and a base station of the first UE,
the positioning session occurs before the first UE is able to finish an initiated connection establishment or reestablishment with a base station, or
a synchronization source quality of a synchronization source for the first UE during a synchronization source change/update is lower than a threshold, or
a combination thereof.

13. The first UE of claim 10, wherein, to determine the one or more conditions have been met for using the exceptional RP-P during the positioning session, the one or more processors are configured to determine that:
a number of UEs participating in the positioning session detected in a non-exceptional RP-P is smaller than a threshold,
a number of UEs participating in the positioning session detected in the exceptional RP-P is greater than a threshold,
the first UE does not yet have sensing results for a target cell after cell reselection, or
a priority of the positioning session is above a threshold, or
a combination thereof.

14. The first UE of claim 10, wherein, to determine the one or more conditions have been met for using the exceptional RP-P during the positioning session, the one or more processors are configured to determine that:
a Channel Busy Ratio (CBR) of a non-exceptional RP-P is higher than a threshold, or
a CBR of the exceptional RP-P is lower than a threshold, or
a combination thereof.

15. The first UE of claim 10, wherein the one or more processors are configured to transmit the one or more reference signals, and wherein, to determine the one or more conditions have been met for using the exceptional RP-P during the positioning session, the one or more processors are configured to determine that:
the first UE does not have sensing results associated with a non-exceptional sidelink RP-P, or
a non-exceptional RP-P is not yet configured, or
a combination thereof.

16. The first UE of claim 10, wherein the one or more processors are further configured to determine the wireless resources of the exceptional RP-P based on a geographical location of the first UE.

17. The first UE of claim 10, wherein the one or more processors are further configured to determine the wireless resources of the exceptional RP-P based on an exceptional RP-P configuration received at the first UE.

18. The first UE of claim 17, wherein the one or more processors are further configured to receive the exceptional RP-P configuration via:
the sidelink connection with the second UE,
a System Information Block (SIB) via a Uu interface with a base station, or
a broadcast message received by the first UE during a positioning session setup phase or a discovery phase.

19. An apparatus for using an exceptional resource pool for positioning (RP-P) for determining a position of a first UE, the apparatus comprising:
means for determining, at the first UE, whether one or more conditions have been met for using the exceptional RP-P during a positioning session, wherein the exceptional RP-P comprises wireless resources for transmitting or receiving one or more reference signals during the positioning session; and
means for, responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P.

20. The apparatus of claim 19, wherein the means for transmitting or receiving the one or more reference signals comprise means for receiving the one or more reference signals, wherein the apparatus further comprises:
means for performing measurements of the received one or more reference signals; and either:
(i) determining the position of the first UE based at least in part on the measurements of the received one or more reference signals, or
(ii) sending information indicative of the measurements of the received one or more reference signals to another device.

21. The apparatus of claim 19, wherein the means for determining the one or more conditions have been met for using the exceptional RP-P during the positioning session comprises means for determining that:
a measurement quality of a SL interface between the first UE and one or more other UEs is lower than a threshold,
a Positioning Resource Quality of a Uu interface between the first UE and a base station is lower than a threshold,
that a radio link failure has occurred between the first UE and a base station of the first UE,
the positioning session occurs before the first UE is able to finish an initiated connection establishment or reestablishment with a base station, or
a synchronization source quality of a synchronization source for the first UE during a synchronization source change/update is lower than a threshold, or
a combination thereof.

22. The apparatus of claim 19, wherein the means for determining the one or more conditions have been met for using the exceptional RP-P during the positioning session comprises means for determining that:
a number of UEs participating in the positioning session detected in a non-exceptional RP-P is smaller than a threshold,
a number of UEs participating in the positioning session detected in the exceptional RP-P is greater than a threshold,
the first UE does not yet have sensing results for a target cell after cell reselection, or
a priority of the positioning session is above a threshold, or
a combination thereof.

23. The apparatus of claim 19, wherein the means for determining the one or more conditions have been met for using the exceptional RP-P during the positioning session comprises means for determining that:
a Channel Busy Ratio (CBR) of a non-exceptional RP-P is higher than a threshold, or
a CBR of the exceptional RP-P is lower than a threshold, or
a combination thereof.

24. The apparatus of claim 19, wherein the means for determining the one or more conditions have been met for using the exceptional RP-P during the positioning session comprises means for determining that:
the first UE does not have sensing results associated with a non-exceptional sidelink RP-P, or
a non-exceptional RP-P is not yet configured, or
a combination thereof.

25. The apparatus of claim 19, further comprising means for determining the wireless resources of the exceptional RP-P based on a geographical location of the first UE.

26. The apparatus of claim 19, further comprising means for determining the wireless resources of the exceptional RP-P based on an exceptional RP-P configuration received at the first UE.

27. The apparatus of claim 26, further comprising means for receiving the exceptional RP-P configuration via:
the sidelink connection with the second UE,
a System Information Block (SIB) via a Uu interface with a base station, or
a broadcast message received by the first UE during a positioning session setup phase or a discovery phase.

28. A non-transitory computer-readable medium storing instructions for using an exceptional resource pool for positioning (RP-P) for determining a position of a first UE, the instructions comprising code for:
determining, at the first UE, whether one or more conditions have been met for using the exceptional RP-P during a positioning session, wherein the exceptional RP-P comprises wireless resources for transmitting or receiving one or more reference signals during the positioning session; and
responsive to a determination that the one or more conditions have been met for using the exceptional RP-P during the positioning session, transmitting or receiving the one or more reference signals, with the first UE, via a sidelink connection between the first UE and a second UE during the positioning session using the exceptional RP-P.

29. The computer-readable medium of claim 28, wherein the instructions further comprise code for:
performing measurements of the received one or more reference signals; and either:
(i) determining the position of the first UE based at least in part on the measurements of the received one or more reference signals, or
(ii) sending information indicative of the measurements of the received one or more reference signals to another device.

30. The computer-readable medium of claim 28, wherein the code for determining the one or more conditions have been met for using the exceptional RP-P during the positioning session comprises code for determining that:
a measurement quality of a SL interface between the first UE and one or more other UEs is lower than a threshold,
a Positioning Resource Quality of a Uu interface between the first UE and a base station is lower than a threshold,
that a radio link failure has occurred between the first UE and a base station of the first UE,
the positioning session occurs before the first UE is able to finish an initiated connection establishment or reestablishment with a base station, or
a synchronization source quality of a synchronization source for the first UE during a synchronization source change/update is lower than a threshold, or
a combination thereof.
